(19) United States
(12) Patent Application Publication
(10) Pub. No.: US 2011/0035254 A1
(43) Pub. Date: Feb. 10, 2011

(54) USER INTERACTION LAYER

(75) Inventor: Ho Leung Ho, Tseung Kwan O (HK)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/535,512

(22) Filed: Aug. 4, 2009

(51) Int. Cl. G06Q 10/00; G06F 3/00; G06F 15/16

(52) U.S. Cl. 705/10; 715/747; 709/203; 715/788

(57) ABSTRACT

A method is disclosed for assessing a consumer's interest in content on a webpage in a client-server architecture. A consumer client terminal displays an interactive display layer, including webpage content from a webpage content server, to a consumer over a background webpage. Interaction data representing the consumer's interaction with the interactive display layer is received and recorded. The interaction data may be used to update the display properties of the interactive display layer. The interactive display layer with the updated display properties may be displayed to the consumer.

### BACKGROUND

1. Technical Field

The disclosed embodiments relate generally to customizable layers on a webpage.

2. Description of the Related Art

An increase in information, products, and services offered through the Internet, as well as dramatic growth in the number and types of consumers using the Internet, has led to a similar growth in advertisers promoting their goods and services through the Internet. Advertisements from advertisement servers may appear in various forms and at various locations on webpages from the Internet. Similarly, other content on a webpage may be static when displayed on the webpage.

Consumers of the information from these advertisements or other content then require a redirection to yet another webpage for additional information or supplemental content. The consumer's level of interaction with the advertisements or other content may be limited to a single click to initiate the redirection. Thus, existing content publishing models may not be adequate to provide the consumer with a degree of flexibility in interacting with on-line content from a webpage and to provide the publishers with a degree of flexibility in assessing a consumer's interest in given content.

### BRIEF SUMMARY

A system and method are described for a user interaction layer in a client-server environment. A method may assess a consumer's interest in content on a webpage in a client-server architecture. A consumer client terminal displays an interactive display layer, including webpage content from a webpage content server, to a consumer over a background webpage. Interaction data representing the consumer's interaction with the interactive display layer is received and recorded. The interaction data may be used to update the display properties of the interactive display layer. The interactive display layer with the updated display properties may be displayed to the consumer.

Other systems, methods, features and advantages will be, or will become apparent to one of ordinary skill in the art upon examination of the following figures and detailed description. All such additional systems, methods, features and advantages are included within this description, are within the scope of the claimed subject matter, and are protected by the following claims.

### BRIEF DESCRIPTION OF THE DRAWINGS

The system may be better understood with reference to the following drawings and description. The elements in the figures are not necessarily to scale, emphasis instead being placed upon illustrating the principles of the system. In the figures, like-referenced numerals designate corresponding parts throughout the different views.

FIG. 1 is an exemplary consumer system architecture;

FIG. 2 is an exemplary server system architecture;

FIG. 3 is an exemplary client-server system architecture;

FIG. 4 is an exemplary client-server system for serving information or advertisements;

FIG. 5 is an exemplary network environment for utilizing a user interaction layer;

FIG. 6 is an exemplary webpage with a content viewing area;

FIG. 7 is an exemplary webpage with an extended content viewing area;

FIG. 8 is an exemplary webpage with an enlarged extended content viewing area;

FIG. 9 is an exemplary webpage with a further enlarged extended content viewing area;

FIG. 10 is an exemplary webpage with a closed extended content viewing area.

FIG. 11 is a content update message flow diagram;

FIG. 12 is an interaction report message flow diagram;

FIG. 13 is a content update flow diagram;

FIG. 14 is an interaction report flow diagram.

### DETAILED DESCRIPTION

A system and method, generally referred to as a system, relate generally to a user interaction layer in a client-server environment. The principles described herein may be embodied in many different forms. The disclosed systems and methods allow consumers to choose their level of interaction with content from a content server. Furthermore, content providers may customize content provided to a consumer according to the interaction the consumer has with the content.

### Exemplary Computer System

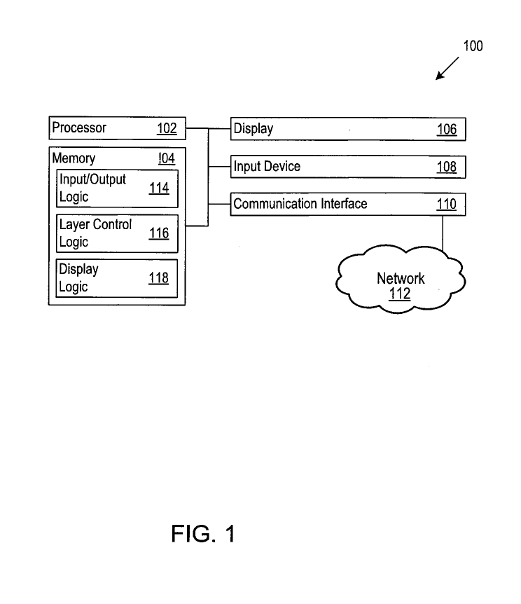

A computer system 100 representing an exemplary client device in which features of the present invention may be implemented will now be described with reference to FIG. 1. The computer system 100 includes a processor 102 for processing information. The computer system 100 includes a memory or other storage device 104 that also may be referred to as a main memory for storing information and instructions to be executed by the processor 102. The main memory 104 also may be used for storing temporary variables or other intermediate information during execution of instructions by the processor 102.

The computer system 100 can also include a display device 106, such as a cathode ray tube (CRT) or Liquid Crystal Display (LCD), for displaying information to a computer user. Typically, an alphanumeric input device 108, including alphanumeric and other keys, may be included in the computer system 100 for communicating information and/or command selections to processor 102. Another type of user input device 108 is a cursor control, such as a mouse, a trackball, touch pad or cursor direction keys for communicating direction information and command selections to processor 102 and for controlling cursor movement on display 106.

A communication interface 110 is also included with the computer system 100 for accessing remote servers or clients via the Internet, for example. The communication interface 110 may include a modem, a network interface card, or other commercially available network interface devices, such as those used for coupling to an Ethernet, token ring, or other type of network 112. Further, the communication interface 110 may include a wireless communication device such as a radio or infrared connection. Examples include a Bluetooth radio, a cellular, WiFi or WiMax radio or any other device for wireless data communication. In this manner, computer system 100 may be coupled to a number of clients and/or other servers via a conventional network infrastructure 112, such as a company's Intranet and/or the Internet, for example.

The main memory 104 includes input/output logic 114, layer control logic 116, and display logic 118. The input/output logic 114 interfaces with the input device 108 and the communications interface 110 to send and receive communications with a consumer and a content server. The layer control logic 116 processes content information from a content server and the interactions from a consumer to determine what is displayed within a content viewing area or an extended content viewing area. The display logic 118 interacts with the display 106 to communicate information to the consumer.

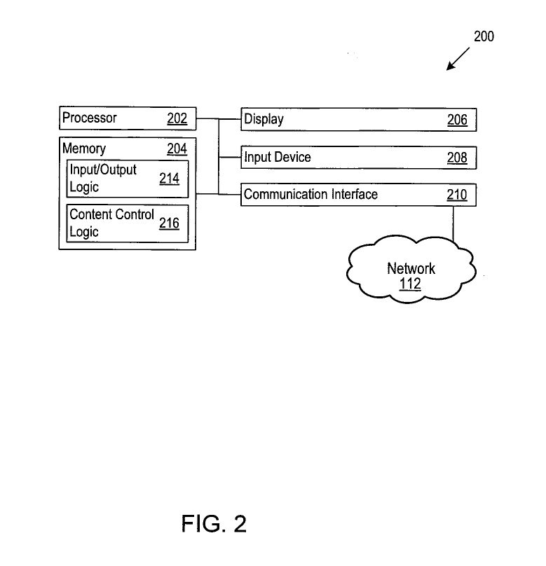

FIG. 2 is an exemplary server system architecture 200. The server system architecture 200 includes a server processor 202 for processing information. Examples of the server processor 202 include processors from the INTEL XEON series and the AMD OPTERON series. The server system architecture 200 includes a server memory 204 that may store information and instructions to be executed by the server processor 202. The server memory 204 also may be used for storing temporary variables or other intermediate information during execution of instructions by the server processor 202. The server memory 204 also may include one or more fast read-write, high-capacity hard drives configured in an RAID structure or with other data redundancy and/or error correction features.

The server system architecture 200 can also include a display device 206, such as a cathode ray tube (CRT) or Liquid Crystal Display (LCD), for displaying information to a system administrator. An alphanumeric input device 208, including alphanumeric and other keys, may also be included in the server system architecture 200 for communicating information and/or command selections to server processor 202.

A communication interface 210 is also included with the server system architecture 200 for accessing remote servers or clients via the Internet, for example. The communication interface 210 may include a modem, a network interface card, or other commercially available network interface devices, such as those used for coupling to an Ethernet, token ring, or other type of network 112. The communication interface 210 may provide a fast network connection and high input/output throughput.

The main memory 204 includes input/output logic 214 and content control logic 202. The input/output logic 214 interfaces with the input device 208 and the communications interface 210 to send and receive communications with a client, such as a consumer device. The content control logic 202 processes content requests and determines and locates the corresponding content. The content control logic 202 may further process and tailor the content for an individual consumer.

### Client-Server Environment

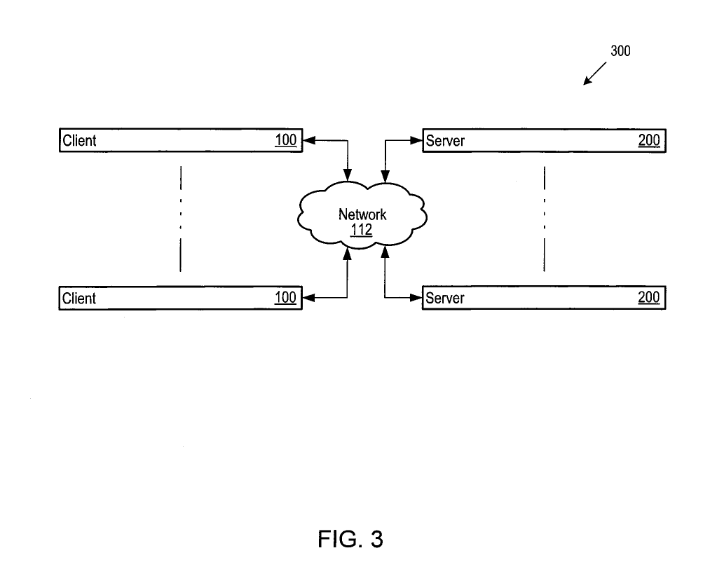

FIG. 3 is a simplified view of an exemplary client-server environment, such as the World Wide Web (web), in which the preferred embodiments may take place. The web follows a client-server model, where “client” and “server” refer to a computer's general role as a requester of data (the client) or a provider of data (the server). Clients 100 and servers 200 communicate using a protocol such as HyperText Transfer Protocol (HTTP). In the web environment, web browsers reside on clients and render web documents (pages or webpages) served by the web servers. The client-server model is used to communicate information between the clients 100 and the servers 200. The web servers 200 are communicably coupled to a network 112, such as the Internet or a wide-area or large-area network (WAN or LAN), and respond to content requests and/or other queries from clients 100. When a consumer selects content by submitting its Uniform Resource Locator (URL), a web browser, such as MOZILLA FIREFOX or MICROSOFT INTERNET EXPLORER, opens a connection to a server 200 and initiates a request (e.g., an HTTP get) for the content. The server 200 delivers the requested content, typically in the form of a text document coded in a standard markup language such as HyperText Markup Language (HTML). The content may also include code in a scripting language, such as Perl or JavaScript, or style sheets in the form of Cascading Style Sheets (CSS).

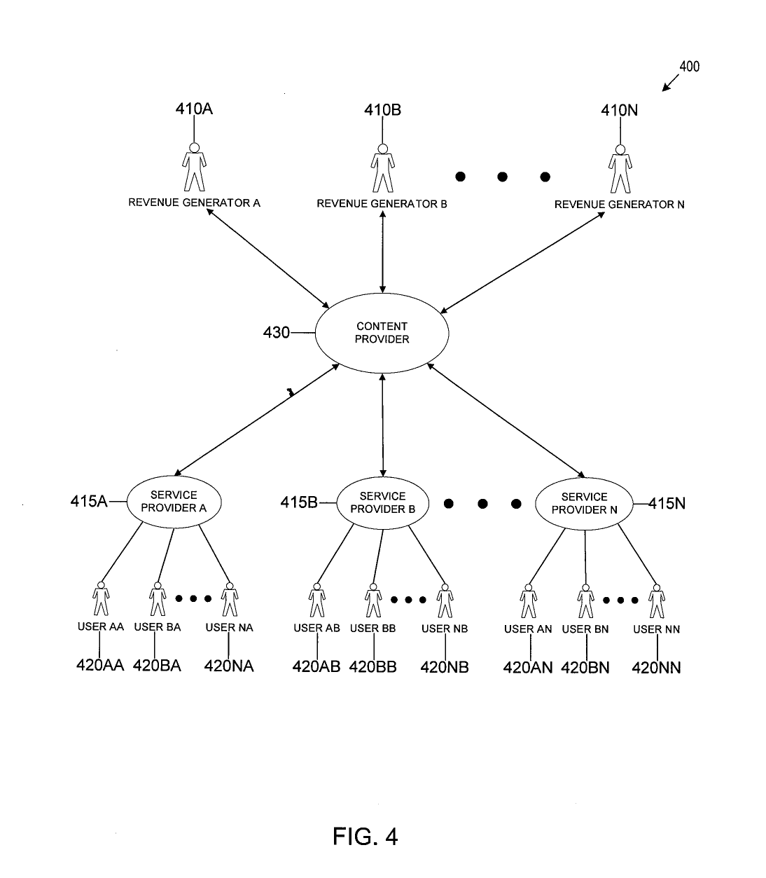

FIG. 4 provides a general overview of a system 400 for serving advertisements with a user interaction layer. Not all of the depicted components may be required, however, and some implementations may include additional components. Variations in the arrangement and type of the components may be made without departing from the spirit or scope of the claims as set forth herein. Additional, different or fewer components may be provided.

The system 400 may include one or more revenue generators 410A, 410B, . . . 410N, generally referred to as the revenue generators 410A-N, such as commercial advertisers, a content provider 430, such as a portal, one or more service providers 415A, 415B, . . . 415N, generally referred to as the service providers 415A-N, more commonly referred to as internet service providers or ISPs, and one or more users 420AA, 420BA, . . . 420NA, 420BA, 420BB, . . . 420BN, . . . 420AN, 420BN, . . . 420NN, generally referred to as the users 420AA-NN, such as information consumers or advertising consumers. The revenue generators 410A-N may pay the content provider 430 to display advertisements, such as online advertisements on a network such as the Internet. The users 420AA-NN may access the advertisements hosted by the content provider 430 through a Web page, search engine, or other online publishing media. The advertisements may be presented by a browser, such as a web browser. The payments may be based on various factors, such as the number of times an advertisement may be displayed to the users 420AA-NN.

The content provider 430 may maintain a web site or web portal, such as a search site, where the content provider 430 may display advertisements of the revenue generators 410A-N to the users 420AA-NN. The content provider 430 may also display advertising content provided by the revenue generators 410A-N in response to a search query from one of the users 420AA-NN. The content provider 430 may share revenue with the service providers 415A-N for displaying advertisements of the revenue generators 410A-N on their networks. Alternatively or in addition the content provider 430 may share revenue with individual web publishers for displaying advertisements of the revenue generators 410A-N on their web sites.

The users 420AA-NN may be consumers of goods or services who may be searching for a business such as the business of one of the revenue generators 410A-N. The users 420AA-NN may communicate with the content provider 430 through the service providers 415A-N. The users 420AA-NN may supply information describing themselves to the content provider 430, such as the location, gender, or age of the users 420AA-NN, or generally any information that may be required for the users 420AA-NN to utilize the services provided by the content provider 430. Alternatively or in addition the content provider 430 may obtain information about the users 420AA-NN from the service providers 415A-N. Any of the information obtained by the content provider 430 may be in the form of hidden information, such as cookie data, computer identification parameters, or service provider-provided information.

In the system 400, the revenue generators 410A-N may interact with the content provider 430, such as via a web application. The revenue generators 410A-N may send information, such as billing, website and advertisement information, to the content provider 430 via the web application. The web application may include a web browser or other application such as any application capable of displaying web content. The application may be implemented with a processor such as a personal computer, personal digital assistant, mobile phone, or any other machine capable of implementing a web application. The revenue generators 410A-N may also receive consumer interaction data and calculate revenue shares from the consumer interaction data.

The users 420AA-NN may also interact individually with the content provider 430, through the service providers 415A-N, such as via a desktop computer, laptop computer or any device capable of communicating with the service providers 415A-N. The users 420AA-NN may interact with the content provider 430 via a web-based application, a standalone application, or any application capable of running on a computing device. The content provider 430 may communicate data to the revenue generators 410A-N over a network and to the users 420AA-NN over a network via the service providers 415A-N. The following examples may refer to a revenue generator A 410A as an online advertiser; however the system 400 may apply to any revenue generators 410A-N who may desire to serve advertisements over a client-server network.

In operation, one of the revenue generators 410A-N, such as revenue generator A 410A, may provide information to the content provider 430. This information may relate to the transaction taking place between the revenue generator A 410A and the content provider 430, or may relate to an account the revenue generator A 410A maintains with the content provider 430. In the case of a revenue generator A 410A who is an online advertiser, the revenue generator A 410A may provide initial information necessary to open an account with the content provider 430.

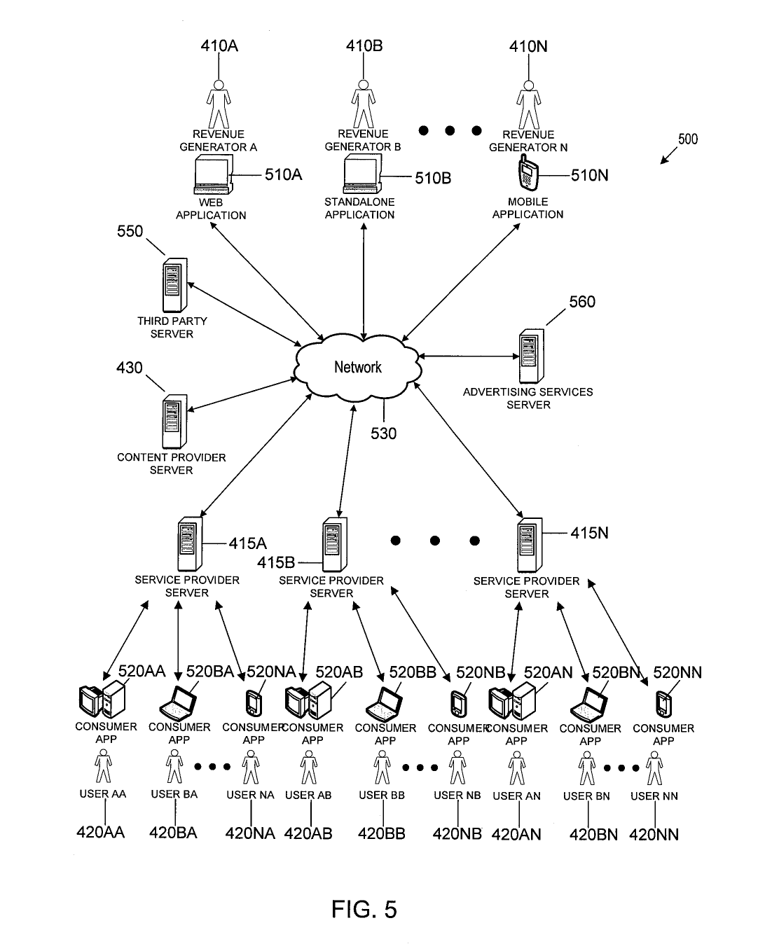

FIG. 5 provides a simplified view of a network environment implementing a system 500 for utilizing a user interaction layer. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 500 may include one or more web applications, standalone applications and mobile applications 510A, 510B, . . . 510N, generally referred to as the applications 510A-N, which may be collectively or individually referred to as client applications of the revenue generators 510A-N. The system 500 may also include one or more consumer applications, or consumer apps 520AA, 520BA, . . . 520NA, 520AB, 520BB, . . . 520NB, . . . 520AN, 520BN, . . . 520NN, generally referred to as the consumer applications 520AA-NN, which may collectively be referred to as client applications of the users 520AA-NN, or individually as a user client application. The system 500 may also include one or more service provider servers 415A, 415B, . . . 415N, generally referred to as the service provider servers 415A-N, content provider server 430, a network 530, a third party server 550, and an advertising services server 560.

Some or all of the service provider servers 415A-N, content provider server 430, third-party server 550 and advertising services server 560 may be in communication with each other by way of network 530 and may be the system or components described above in FIG. 2. The service provider servers 415A-N, content provider server 430, third-party server 550 and advertising services server 560 may each represent multiple linked computing devices. Multiple distinct third party servers, such as the third-party server 250, may be included in the system 500. The third-party server 550 may be one of the service provider servers 415A-N or a server associated with, or in communication with one of the service provider servers 415A-N.

The network 530 may include wide area networks (WAN), such as the internet, local area networks (LAN), campus area networks, metropolitan area networks, or any other networks that may allow for data communication. The network 530 may be divided into sub-networks. The sub-networks may allow access to all of the other components connected to the network 530 in the system 500, or the sub-networks may restrict access between the components connected to the network 530. The network 530 may include a public or private network connection and may include, for example, a virtual private network or an encryption or other security mechanism employed over the public Internet, or the like.

The revenue generators 410A-N may use a web application 510A, standalone application 510B, or a mobile application 510N, or any combination thereof, to communicate to the service provider servers 415A-N, content provider server 430, third-party server 550 and/or advertising services server 560, such as via the network 530. The service provider servers 415A-N, content provider server 430, third-party server 550 and/or advertising services server 560 may communicate to the revenue generators 410A-N via the network 530, through the web applications, standalone applications or mobile applications 510A-N.

The users 420AA-NN may use one of the mobile applications 520AA-520NN, such as a mobile web browser, to communicate with the revenue generators 410A-N, content provider server 430, third-party server 550 and/or advertising services server 560, via the service provider servers 415A-N and the network 530. The revenue generators 410A-N, content provider server 430, third-party server 550 and/or advertising services server 560 may communicate to the users 420AA-NN via the network 530 and the service provider servers 415A-N, through the consumer applications 520AA-NN.

The web applications, standalone applications and mobile applications, 510A-N and consumer applications 520AA-NN may communicate through the network 530 in any configuration that supports data transfer. This may include a data connection to the network 530 that may be wired or wireless. Any of the web applications, standalone applications and mobile applications, 510A-N and consumer applications 520AA-NN may individually be referred to as a client application. The web application 510A may run on any platform that supports web content, such as a web browser or a computer, a mobile phone, personal digital assistant (PDA), pager, network-enabled television, digital video recorder, such as TIVO®, automobile and/or any appliance capable of data communications.

The standalone applications 510B may run on a machine that may have a processor, memory, a display, a user interface and a communication interface. The processor may be operatively connected to the memory, display and the interfaces and may perform tasks at the request of the standalone applications 510B or the underlying operating system. The memory may be capable of storing data. The display may be operatively connected to the memory and the processor and may be capable of displaying information to the revenue generator B 410B. The user interface may be operatively connected to the memory, the processor, and the display and may be capable of interacting with a revenue generator A 410A. The communication interface may be operatively connected to the memory, and the processor, and may be capable of communicating through the network 530 with the service provider servers 415A-N, content provider server 430, third-party server 550 and/or advertising services server 560. The standalone applications 510B may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others.

The mobile application 510N may run on any mobile device which may have a data connection. In one example, the mobile application 510N is a mobile browser. The mobile device may be one of a broad range of electronic devices which may include mobile phones, PDAs, and handheld devices. The mobile device may have a reduced feature set, such as a smaller keyboard and/or screen, and may be incapable of supporting a traditional web search.

The data connection of the consumer devices may be a cellular connection, such as a GSM/GPRS/WCDMA connection, a wireless data connection, an internet connection, an infra-red connection, a Bluetooth connection, or any other connection capable of communicating data. The data connection may be used to connect directly to the network 530, or to connect to the network 530 through the service provider servers 415A-N. The service provider servers 415A-N may control the access the consumer applications 510AA-NN may have to the network. The service provider servers 415A-N may also control the technology supporting the respective consumer applications 520AA-NN. The service provider servers 415A-N may include any server that routes requests from many individual users or devices through a limited set of IP addresses. The service provider servers 415A-N may include one or more of the following: an application server, a data source, such as a database server, a middleware server, and an advertising services server.

The service provider servers 415A-N may co-exist on one machine or may be running in a distributed configuration on one or more machines. The service provider servers 415A-N may receive requests from the users 420AA-NN and the revenue generators 410A-N and may serve web pages and/or applications to the users 420AA-NN and/or to the revenue generators 110A-N based on their requests.

The content provider server 430 may include one or more of the following: an application server, a data source, such as a database server, a middleware server, and an advertising services server. The content provider server 430 may facilitate communication of data between the users 420AA-NN, the service provider servers 415A-N, and the revenue generators 110A-N. The third party server 550 may include one or more of the following: an application server, a data source, such as a database server, a middleware server, and an advertising services server. The third party server 550 may co-exist on one machine or may be running in a distributed configuration on one or more machines. The advertising services server 560 may provide a platform for the inclusion of advertisements in pages, such as web pages or applications. The advertising services server 560 may be used for providing mobile advertisements that may be displayed to the users 420AA-NN.

The service provider servers 415A-N, the content provider server 430, the third party server 550 and the advertising services server 560 may be one or more computing devices of various kinds, such as the computing device in FIG. 2. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 510A may employ HTTP to request information, such as a web page, from a web server, which may be a process executing on one of the service provider servers 415A-N, the content provider server 430, the third party server 550 or the advertising services server 560.

There may be several configurations of database servers, application servers, middleware servers and advertising services servers included in the service provider servers 415A-N, the content provider server 430, the third party server 550 and the advertising services server 560. Database servers may include MICROSOFT SQL SERVER, ORACLE, IBM DB2 or any other database software, relational or otherwise. The application server may be APACHE TOMCAT, MICROSOFT IIS, ADOBE COLDFUSION, YAPACHE or any other application server that supports communication protocols. The middleware server may be any middleware that connects software components or applications. The application server on the service provider servers 415A-N, the content provider server 430, the third party server 550 or the advertising services server 560 may serve pages, such as web pages, to the users 420AA-NN and the revenue generators 410A-N. The advertising services server 560 may provide a platform for the inclusion of advertisements in pages, such as web pages. The advertising services server 260 may also exist independent of the service provider servers 415A-N, the content provider server 430 and the third party server 550.

The network 530 may be configured to couple one computing device to another computing device to enable communication of data between the devices. The network 530 may generally be enabled to employ any form of machine-readable media for communicating information from one device to another. The network 530 may include one or more of a wireless network, a wired network, a local area network (LAN), a wide area network (WAN), a direct connection such as through a Universal Serial Bus (USB) port, and the like, and may include the set of interconnected networks that make up the Internet. The network 530 may include any communication method by which information may travel between computing devices.

### Exemplary Interaction

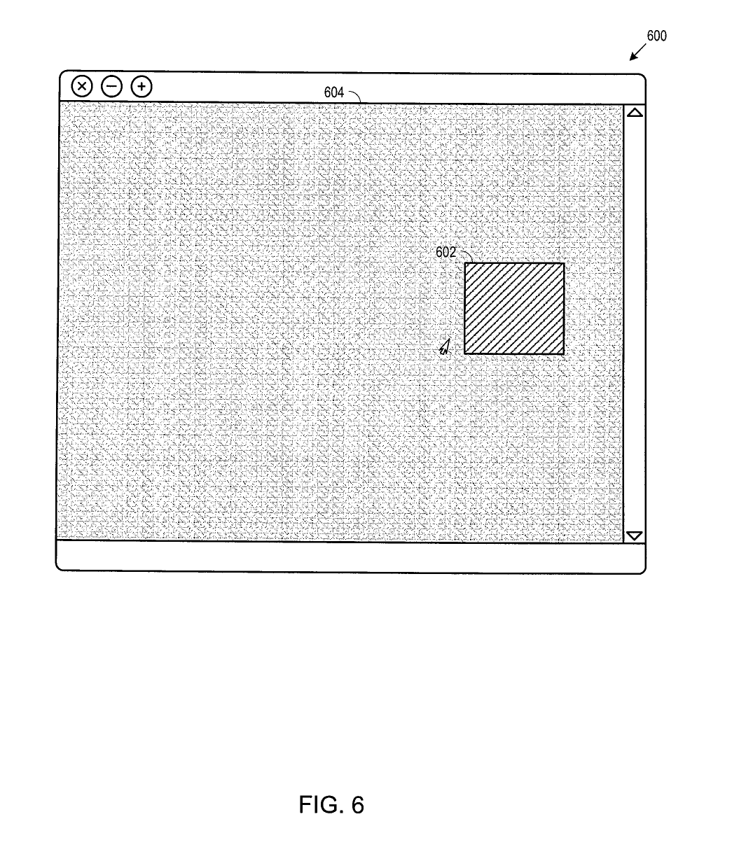

FIG. 6 illustrates an exemplary webpage 600. A consumer may view the webpage 600 from a client device, such as a desktop computer terminal, a laptop or portable computer, a personal digital assistant (PDA) or other data processing device that allows user viewing or interaction with webpages. The webpage 600 includes a content viewing area 602 and background content 604. The background content 604 provides a backdrop for the content viewing area 602, among other things. The background content 604 may be a solid color, pattern, a wallpaper image, text, or any content that serves to provide context to the webpage 600 or to set forth the viewing area 602. The viewing area 602 may include a text field, a graphic, a streaming video, an animation file, an embedded application for playing audio files, or an advertisement. For this example, the viewing area 602 is a graphical advertisement in the form of a JPEG image with dimensions of 300 pixels by 250 pixels. The consumer may interact with the graphical advertisement by clicking on the graphical advertisement with a cursor. Clicking on the graphical advertisement may redirect the consumer to a webpage with a user interaction layer or it may activate a user interaction layer sitting above the background content 604. Clicking and dragging a mouse while over a graphical advertisement may also activate the user interaction layer. The function call below may indicate that the consumer has just clicked the mouse while over a graphical advertisement but has not yet performed any further action:

cpe_layer.onMouseDown {

clip(0, 0, 0, 0)

}

The webpage displays a user interaction layer, here called a “cpe layer”, on the screen viewed by the consumer. When the mouse button is clicked while over the cpe layer, the cpe layer calls the “clip” function and feeds the function four inputs. The clip function takes four inputs left, top, right, and bottom of the form clip (left, top, right, bottom) and shifts the corresponding edge of a viewing area within the user interaction layer according to the input value. Positive values of left, top, right, and bottom indicate a positive displacement in the corresponding direction of the consumer's screen. During activation, the user interaction layer may have no visible dimension because its “clip” property is set to (0, 0, 0, 0). This coordinates of the user interaction layer may be anchored, or referenced, to the top left most corner of the base advertisement. When a consumer clicks and drags the mouse on a base advertisement indicator, such as a tiny handle icon, the clip function may be called continuously with updated mouse coordinates as parameters. Other coordinate systems may also be substituted without detracting from the purposes of the system.

The clip function may be called continually or dynamically, for example, when the mouse button is clicked and dragged while over one of the advertisement's edges. The content within the viewing area may also be continually or dynamically updated. In one example, clicking and dragging may gradually expose larger portions of an underlying image or advertisement. The underlying image or advertisement in the viewing area may gradually expand or retract while following the consumer's mouse movements until it reaches a predetermined dimension limit or until the consumer releases the mouse button.

In other embodiments, when the viewing area reaches above a predetermined size, the clip function may change the underlying media. The properties of the content in the viewing area may change. For example, the underlying image or advertisement may change from one size to another or from one resolution to another. Alternatively, the type of underlying media may change altogether. Examples of a media type change would be from a static JPEG image to a streaming or ADOBE FLASH video with video controls, or from a pure text paragraph to a related graphical image.

The user interaction layer provides a solution to the constant struggling issue of lack of real estate on a web page for accommodating higher value content at the consumer's choosing. It allows online consumers to take control of how they want the contents of a webpage to be displayed and interacted with. The user interaction layer is a user-initiated, non-intrusive way of letting a consumer take the initiative to explore and interact with the page contents, and the results are easy to measure. Additionally, the interaction layer provides the human user with an improved and more efficient way of interacting with and extracting the information presented through the webpage.

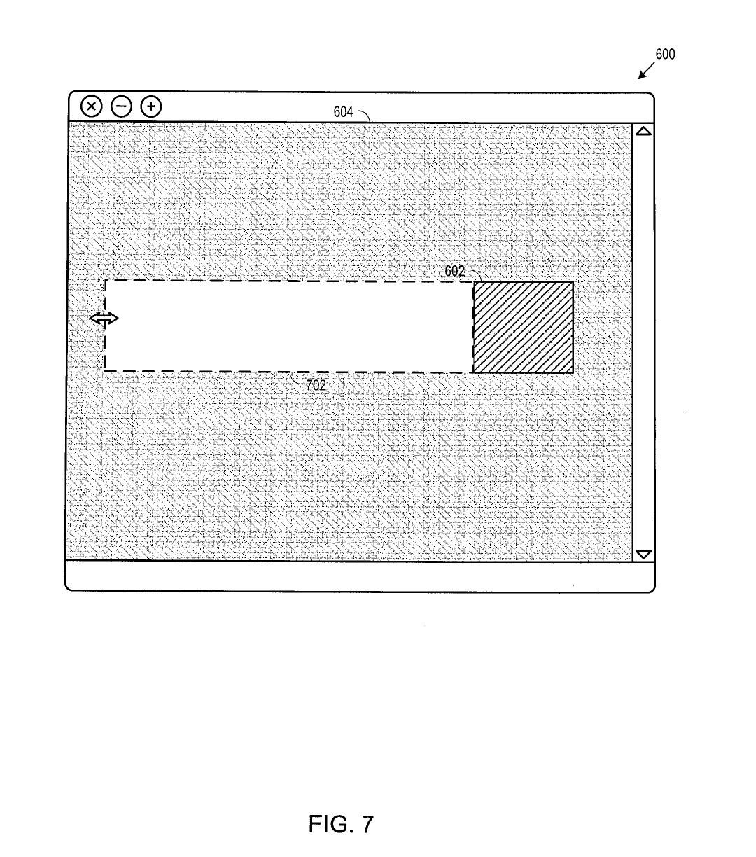

FIG. 7 illustrates the webpage 600 after the consumer has clicked and dragged the left edge of the advertisement. By clicking and dragging, the consumer creates an extended content viewing area 702. The extended content viewing area 702 may be a selected area of expansion for the advertisement of an additional 1000 pixels by 250 pixels. The total viewing area then includes the content viewing area 602 plus the extended content viewing area 702. The relevant function call may be:

cpe_layer.onMouseDown {

clip(1000, 0, 0, 0)

}

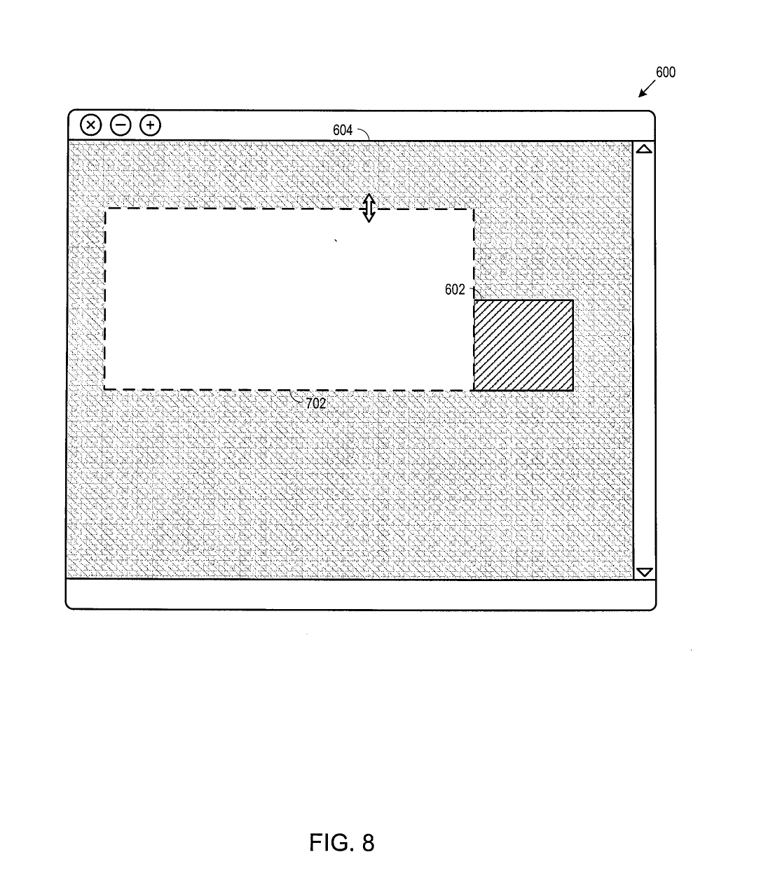

FIG. 8 illustrates the webpage 600 after the consumer has clicked and dragged the top edge of the extended content viewing area 702. Clicking and dragging may expand the extended content viewing area 702 to include a total area of 1000 pixels by 500 pixels. The relevant function call may be:

cpe_layer.onMouseDown {

clip(0, 250, 0, 0)

}

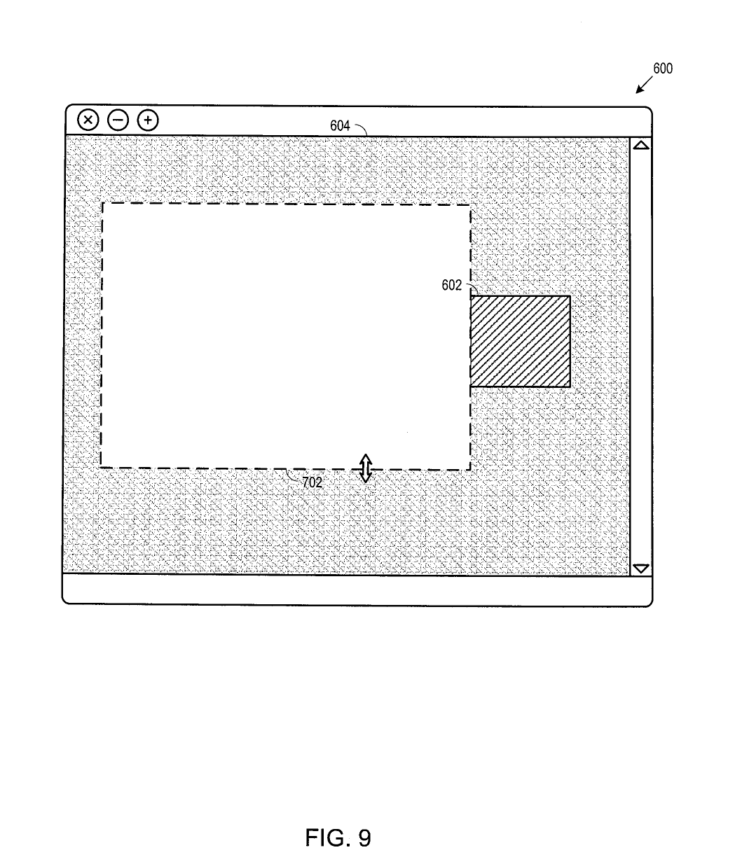

FIG. 9 illustrates the webpage 600 after the consumer has clicked and dragged the bottom edge of the extended content viewing area 702. Clicking and dragging may expand the extended content viewing area 702 to include a total area of 1000 pixels by 750 pixels. The relevant function call may be:

cpe_layer.onMouseDown {

clip(0, 0, 0, 250)

}

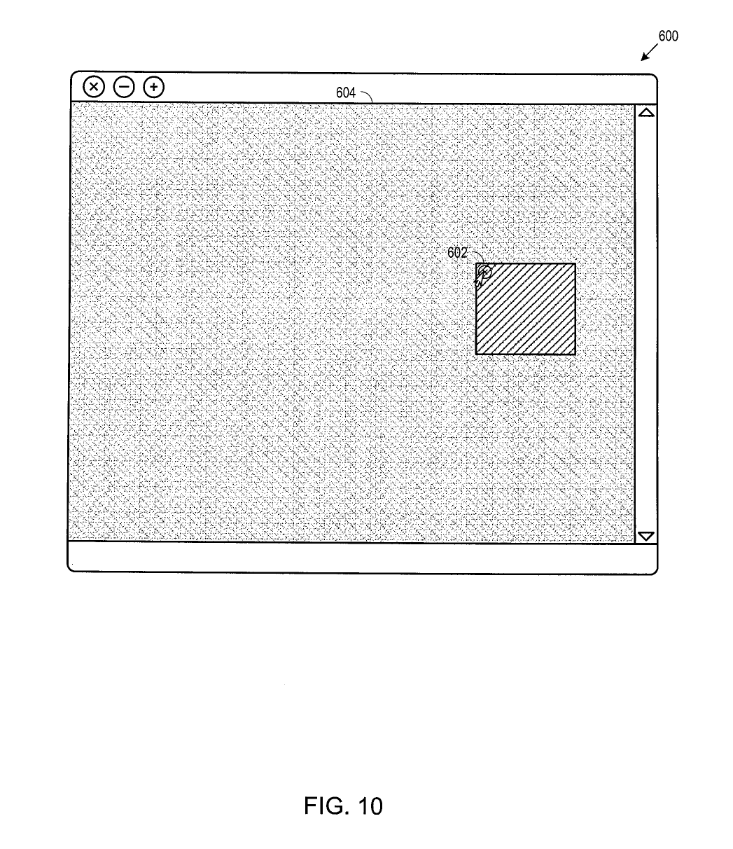

FIG. 10 illustrates the webpage 600 after the consumer has clicked on a “close” button. Clicking on the close button may close the extended content viewing area 702. The relevant function call may be:

cpe_layer.onMouseDown {

clip(−1000, −250, 0, −250)

}

### Message Flows

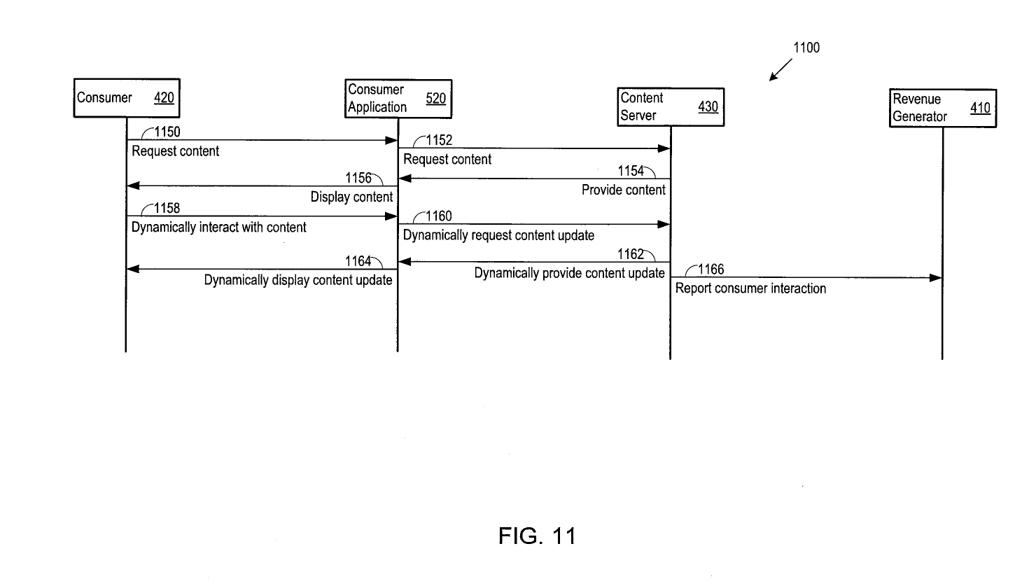

FIG. 11 is a content update message flow diagram 1100 for dynamically updating content in a user interaction layer. The message flow diagram 1100 illustrates an exemplary sequence of communications among a consumer 420, a consumer application 520 and a content server 430. The communications between the consumer 420 and the consumer application 520 may occur through a mouse, keyboard or other input device. The interaction between the consumer application 520 and the content server 430 may occur through a network, such as the internet.

The consumer 420 requests from the consumer application 520 information or content in communication 1150. The request may originate from an instruction to open a web browser or for an instruction to access a specific Uniform Resource Locator (URL). The consumer application 520 receives the instructions and forwards to the content server 430 the request in communication 1152.

The content server 430 processes the request, retrieves the appropriate content, and returns the content in communication 1154. The content may include data for displaying a webpage, including HyperText Markup Language (HTML) or JavaScript code, JPEG images, or ADOBE Flash video or any other type of data or information that may be useful to the consumer or requested by the consumer. The consumer application 520 processes the content and provides a display of the content to the consumer 420 in communication 1156. The content includes an interactive display layer and background content. In one example, the display of the content is that illustrated by webpage 600 in FIG. 6.

The consumer 420 dynamically interacts with the displayed content within the consumer application 520 in communication 1158. In this manner, the consumer 420 expresses an interest in the displayed content, and the consumer's level of interest may be correlated with the degree, frequency and type of interaction with the content. The interest level of the consumer 420 may be measured on a continual or dynamic basis. The interest level may be measured by one of many objective measures, such as the duration of time a cursor hovers over a specific area, the manipulation of a content viewing area, the number of mouse clicks on the content viewing area, the size of the content viewing area, how long content is displayed without further consumer interaction (for non-interaction-based content), or the amount of consumer input (e.g., keystrokes, mouse clicks) directed towards a particular application (for interaction-based content). Another objective measure of consumer interest level may be a combination of factors, including those above. In one example, an indexing of the consumer's interest is measured at 1 millisecond intervals after a consumer's mouse-click-and-drag on a content viewing area multiplied by a factor corresponding to the size of the content viewing area. Other factors may be considered in indexing the consumer's interest, such as the content of the viewing area, whether and which data form was completed, whether an acquisition was committed, and whether an extra message window was opened from the content viewing area. These objective measures may be tracked during the consumer's content viewing and exploration session. One illustration of a consumer's dynamic interaction is that illustrated by webpage 600 in FIG. 7.

The consumer application 520 dynamically requests content updates in communication 1160. The requests correspond to the consumer's interaction with the content. The content server 430 may record and track the consumer's interaction with the content and dynamically provide updates to the content in communication 1162. The interaction with the content may provide an advertiser or information provider associated with the content server 430 with the opportunity to more fully engage the consumer 420 with the provided content. For example, the information provider may wish to provide an interested consumer with a higher resolution image or a more complex or engaging multimedia presentation. The information provider may also tailor the content to the individual consumer. The consumer application 520 processes the content updates and updates the display properties of the webpage content in memory. The consumer application 520 dynamically displays the content updates in communication 1164.

The content server 430 may optionally report the consumer interaction to a revenue generator 410 in communication 1166. The reporting communication may occur at any point where a degree or extent of consumer interaction may be extrapolated. For example, the reporting communication may occur after the content server 430 has processed a content update request from the consumer application 520, or a reporting communication may be made directly from the consumer application 520 to the revenue generator 410. In this manner, the revenue generator 410 may monetize the consumer's interaction to a degree that correlates to the consumer's level of interest in the content provided.

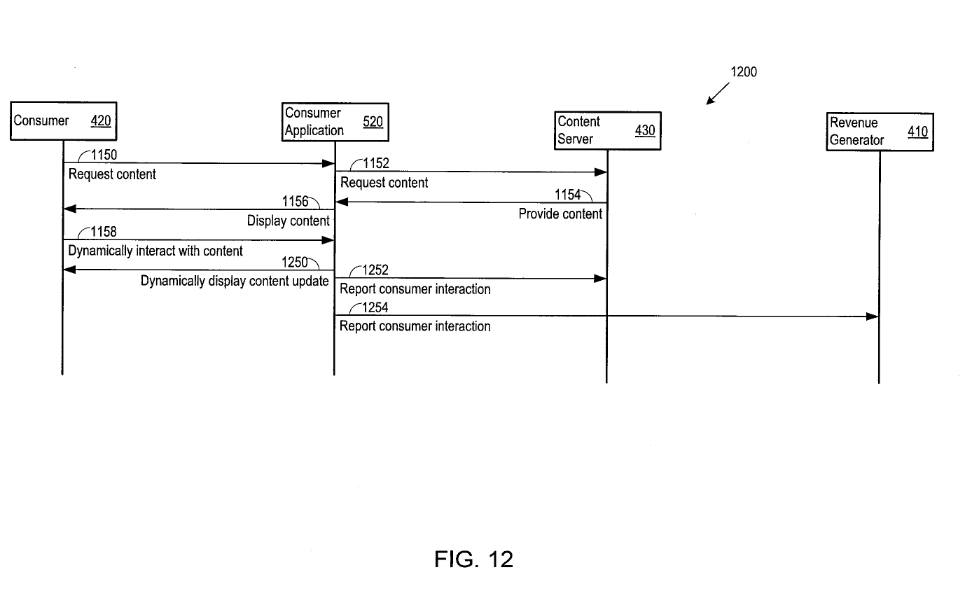

FIG. 12 is an interaction report message flow diagram 1200. The message flow diagram 1200 follows the message flow diagram 1100 in that the consumer 420 requests from the consumer application 520 information or content in communication 1150. The consumer application 520 receives the instructions and forwards to the content server 430 the request in communication 1152. The content server 430 processes the request, retrieves the appropriate content, and returns the content in communication 1154. The consumer application 520 processes the content and provides a display of the content to the consumer 420 in communication 1156. The consumer 420 dynamically interacts with the displayed content within the consumer application 520 in communication 1158.

However, the message flow diagram 1200 deviates from the message flow diagram 1100 in that all the relevant content resides with the consumer application 520 from the initial content retrieval 1154. The consumer application 520 dynamically updates the content display in communication 1250 without necessarily requesting the content server 430 for additional or updated content. Instead, the consumer application 520 reports the consumer interaction to the content server 430 in communication 1252.

For example, the content originally displayed to the consumer 420 may include a small section of a large image stored with the consumer application 520. As the consumer 420 clicks and drags on one edge of the small section, the consumer application 520 may display successively larger portions of the large image until the full image is displayed. The consumer application 520 may then report the click-and-drag to the content server 430.

The consumer application 520 may optionally report the consumer interaction directly to a revenue generator 410 in communication 1254. The reporting communication may occur at any point where a degree or extent of consumer interaction may be extrapolated. In this manner, the revenue generator 410 may more quickly monetize the consumer's interaction to a degree that correlates to the consumer's level of interest in the content provided. The content server 430 may alternatively report the consumer interaction after it receives the consumer interaction report from communication 1252.

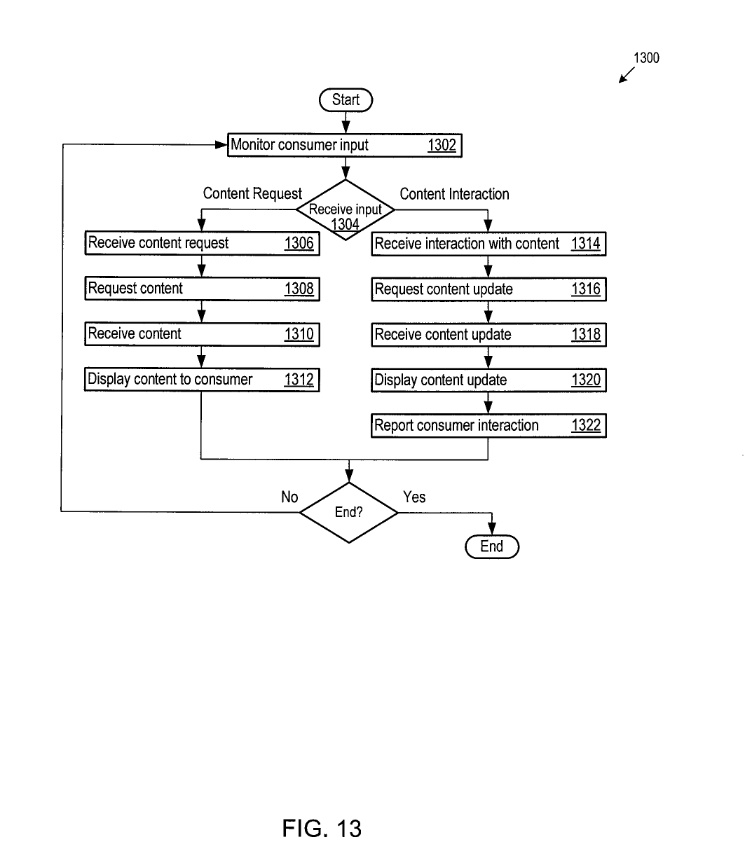

FIG. 13 is a content update flow diagram 1300. The content update flow diagram 1300 illustrates an exemplary flow for a consumer application on a client device. The exemplary flow may be implemented, for example, by a processor of the client device operating in response to data and instructions stored in memory at the client device and in response to input information from the consumer received, for example, as entries on a keypad or actuation of a touch-sensitive display. The client device monitors a consumer's input to the consumer application in box 1302. Once the consumer application receives input from the consumer, the consumer application determines whether the input reflects a content request or interaction with previously displayed content in box 1304.

If the consumer input reflects a content request, the consumer application receives the content request in box 1306. The consumer application requests content in box 1308. The request may be made to a content server. The consumer application receives content in box 1310 and displays the content to the consumer in box 1312.

If the consumer's input reflected interaction with previously displayed content, the consumer application receives data reflecting the interaction with the content in box 1314. The consumer application requests content update in box 1316. The request may be made to a content server. The consumer application receives the content update in box 1318 and displays the content update to the consumer in box 1320. The consumer application reports the consumer interaction in box 1322. The report may be made to the content server or to a revenue generator. Alternatively, the content server may send a consumer interaction report to the revenue generator.

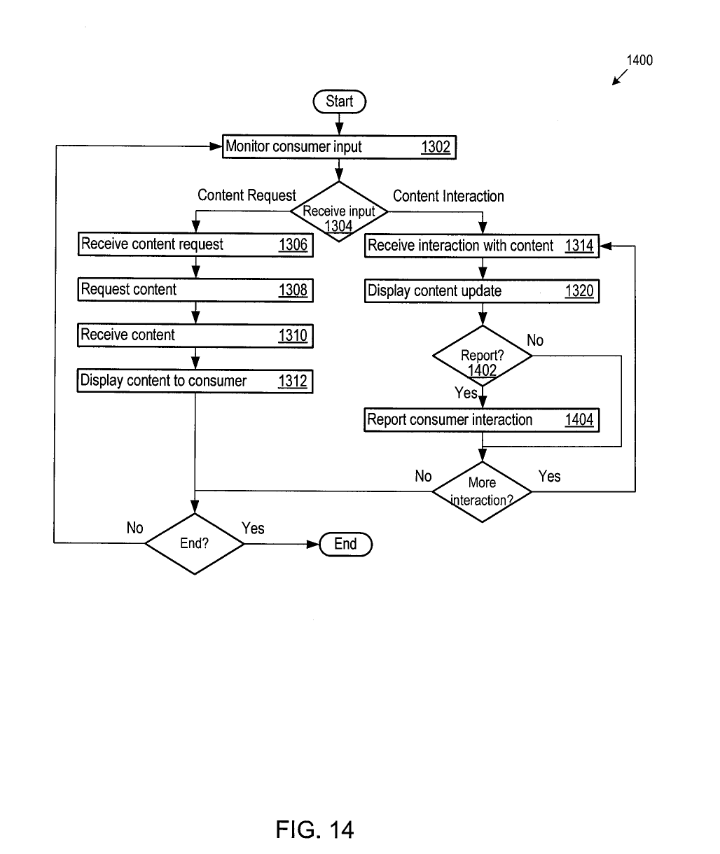

FIG. 14 is an interaction report flow diagram 1400. Like the flow diagram 1300 of FIG. 13, FIG. 14 illustrates operation of a consumer application at the client device. The flow diagram 1400 follows the flow diagram 1300 in that the consumer application monitors a consumer's input to the client device in box 1302. Once the consumer application receives input from the consumer, the consumer application determines whether the input reflects a content request or interaction with previously displayed content in box 1304. If the consumer input reflects a content request, the consumer application receives the content request in box 1306. The consumer application requests content in box 1308. The request may be made to a content server. The consumer application receives content in box 1310 and displays the content to the consumer in box 1312. If the consumer's input reflected interaction with previously displayed content, the consumer application receives data reflecting the interaction with the content in box 1314. The consumer application displays the content update to the consumer in box 1320.

However, the flow diagram 1400 deviates from the flow diagram 1300 in that all the relevant content resides with the consumer application on the client device from the initial content retrieval. So, the consumer application displays the content update to the consumer without necessarily requesting additional or updated content from the content server. The consumer application determines whether to generate a report of the consumer's interaction to the content server in box 1402. If a report should be generated, the consumer application reports the consumer interaction in box 1404. The consumer interaction report may be made from the consumer interaction to the content server, or alternatively to a revenue generator.

The methods described herein may be implemented by software programs executable by a computer system. Further, implementations may include distributed processing, component/object distributed processing, and parallel processing. Alternatively or in addition, virtual computer system processing may be constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

The disclosed methods, processes, programs, and/or instructions may be encoded in a signal-bearing medium, a computer-readable medium such as a memory, programmed within a device such as on one or more integrated circuits, or processed by a controller or a computer. If the methods are performed by software, the software may reside in a memory resident to or interfaced to a communication interface, or any other type of non-volatile or volatile memory. The memory may include an ordered listing of executable instructions for implementing logical functions. A logical function may be implemented through digital circuitry, through source code, through analog circuitry, or through an analog source such as that occurring through an analog electrical, audio, or video signal. The software may be embodied in any computer-readable or signal-bearing medium, for use by, or in connection with, an instruction executable system, apparatus, or device. Such a system may include a computer-based system, a processor-containing system, or another system that may selectively fetch instructions from an instruction executable system, apparatus, or device that may also execute instructions.

Although selected aspects, features, or components of the implementations are depicted as being stored in memories, all or part of the systems, including the methods and/or instructions for performing such methods consistent with the click traffic scoring system, may be stored on, distributed across, or read from other computer-readable media, for example, secondary storage devices such as hard disks, floppy disks, and CD-ROMs; a signal received from a network; or other forms of ROM or RAM either currently known or later developed.

Specific components of the computer system 900 may include additional or different components. A processor may be implemented as a microprocessor, microcontroller, application specific integrated circuit (ASIC), discrete logic, or a combination of other types of circuits or logic. Similarly, memories may be DRAM, SRAM, Flash, or any other type of memory. Parameters (e.g., popularity rankings), databases, and other data structures may be separately stored and managed, may be incorporated into a single memory or database, or may be logically and physically organized in many different ways. Programs or instruction sets may be parts of a single program, separate programs, or distributed across several memories and processors.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The computer-readable medium may selectively be, but is not limited to, an electronic, magnetic, optical, electromagnetic, infrared, or semiconductor system, apparatus, device, or propagation medium. A non-exhaustive list of examples of a machine-readable medium may include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A computer-readable medium may also include a tangible medium upon which software is printed, as the software may be electronically stored as an image or in another format (e.g., through an optical scan), then compiled, and/or interpreted, or otherwise processed. The processed medium may then be stored in a computer and/or machine memory.

While various embodiments of the user interaction layer have been described, it will be apparent to those of ordinary skill in the art that many more embodiments and implementations are possible within the scope of the invention. Accordingly, the invention is not to be restricted except in light of the attached claims and their equivalents.

1. A method for assessing a consumer's interest in content on a webpage in a client-server architecture, the method comprising:
displaying an interactive display layer, including webpage content from a webpage content server, to a consumer on a client terminal display over a background webpage;
receiving interaction data representing the consumer's interaction with the interactive display layer;
recording the interaction data;
updating the display properties of the interactive display layer; and
displaying the interactive display layer with the updated display properties to the consumer on the client terminal display over the background webpage.

2. The method of claim 1 where the display properties of the interactive display layer includes a left viewing edge location, a right viewing edge location, a top viewing edge location and a bottom viewing edge location, and where updating the display properties of the interactive display layer comprises shifting one of the viewing edge locations in correspondence to the consumer's interaction with the interactive display layer.

3. The method of claim 2 where updating the display properties of the interactive display layer further comprises changing the webpage content within the interactive display layer in correspondence to the shift in the viewing edge location.

4. The method of claim 2 where shifting the edge location occurs in real time.

5. The method of claim 1, further comprising:
sending the interaction data and a webpage content update request to the webpage content server; and
receiving updated webpage content from the webpage content server;
where the display properties of the interactive display layer are updated with the updated webpage content.

6. The method of claim 5 where the webpage content comprises low-resolution image data and the updated webpage content comprises high-resolution image data.

7. The method of claim 5 where the webpage content comprises a small amount of information and the updated webpage content comprises a larger amount of information.

8. The method of claim 7 where the small amount of information comprises a small amount of text and the larger amount of information comprises a larger amount of text.

9. The method of claim 7 where the small amount of information comprises a small pixel count image and the larger amount of information comprises a larger pixel count image.

10. The method of claim 5 where the webpage content includes a first type of multimedia content and where the updated webpage content includes a second type of multimedia content.

11. The method of claim 10 where the first type of multimedia content is a JPEG image and where the second type of multimedia content is an ADOBE FLASH video.

12. The method of claim 1 where updating the display properties of the interactive display layer occurs in real time.

13. The method of claim 1, further comprising sending the interaction data to an interaction evaluator.

14. The method of claim 13 where the interaction evaluator is a revenue generator.

15. A method for assessing a consumer's interest in content on a webpage in a client-server architecture, the method comprising:
sending, from a webpage content server, an interactive display layer, including webpage content, to a consumer client terminal for display over a background webpage;
receiving, at a webpage content server, consumer interaction data and a webpage content update request from the consumer client terminal;
determining, at a webpage content server, a webpage content update based on the consumer interaction data; and
sending, from a webpage content server, the webpage content update to the consumer client terminal;
where the webpage content update adjusts display properties of the interactive display layer on the consumer client terminal.

16. The method of claim 15 where determining a webpage content update comprises:
selecting a first webpage content update when the consumer interaction data reflects a first amount of consumer interaction activity; and
selecting a second webpage content update when the consumer interaction data reflects a second amount of consumer interaction activity.

17. The method of claim 16 where the webpage content comprises low-resolution image data, the first webpage content update comprises high-resolution image data, and the second webpage content update comprises streaming video data.

18. The method of claim 15, further comprising:
evaluating the consumer interaction data for an objective measure of the consumer's interest in content on the webpage; and
generating a revenue share from the objective measure of the consumer's interest.

19. The method of claim 18 where the objective measure of the consumer's interest comprises one or more of creation of an expanded content viewing area and manipulation of the expanded content viewing area.
